(19) United States
(12) Patent Application Publication
(10) Pub. No.: US 2022/0092082 A1
(43) Pub. Date: Mar. 24, 2022

(54) LOGIN BASED DEVICE DATA SYNCHRONIZATION

(71) Applicant: Hewlett-Packard Development Company, L.P., Spring, TX (US)

(72) Inventor: Donghee LEE, Seongnam-si (KR)

(21) Appl. No.: 17/418,462

(22) PCT Filed: Mar. 3, 2020
(86) PCT No.: PCT/US2020/020768

§ 371 Date: Jun. 25, 2021

(30) Foreign Application Priority Data
Sep. 30, 2019 (KR) 10-2019-0121067

(51) Int. Cl. G06F 16/27; G06F 16/23; G06F 16/21; H04L 67/1095

(52) U.S. Cl. CPC G06F 16/273; H04L 67/1095; G06F 16/21; G06F 16/235

(57) ABSTRACT

Login-based device data synchronization of a computing device operating with at least one processor is disclosed. An example computing device receives a login request with respect to an administrator account from a user terminal, authenticates the administrator account, and determines a device list included in a management scope of the administrator account. In addition, the computing device collects and stores device data from devices included in the device list, and provides the stored device data to the user terminal.

### BACKGROUND

There are many kinds of data provided by a device, and it takes a certain time for a server to collect data from the device. A server collecting data of a plurality of devices may collect data from devices in advance and provide a user with stored device data at a desired time.

### BRIEF DESCRIPTION OF THE DRAWINGS

Various examples will be described below by referring to the following figures.

FIG. 1 illustrates an environment in which a device management system hierarchically manages devices according to an example.

FIG. 2 is a schematic diagram of a management system according to an example.

FIG. 3 is a flowchart of a method for periodic synchronization of device data according to an example.

FIG. 4 is a flowchart of a method for synchronizing device data based on a login according to an example.

FIG. 5 is a flowchart of a method for synchronizing device data based on a login according to an example.

FIG. 6 is a flowchart of a method for synchronizing device data based on a login according to an example.

FIG. 7 is a schematic diagram of hardware of a computing device according to an example.

### DETAILED DESCRIPTION

In the following description, examples are shown and described. As those skilled in the art would realize, the examples may be modified in various different ways, all without departing from the spirit or scope of the present invention. Accordingly, the drawings and description are to be regarded as illustrative in nature and not restrictive.

Unless explicitly described to the contrary, the word “comprise” and variations such as “comprises” or “comprising” will be understood to imply the inclusion of stated elements but not the exclusion of any other elements.

In addition, terms such as “-er”, “-or”, and “module” described in the specification refer to units for processing at least one function or operation and can be implemented by hardware components or software components and combinations thereof.

A server and a device may be composed of hardware including at least one processor, a memory, a communication apparatus, etc., and a program executed in combination with hardware may be stored in a designated location. The hardware may have a configuration and performance to implement an example method as described below. The program may include instructions that implement an method of operation as described with reference to the drawings and is executed in combination with hardware such as a processor and a memory.

In the following description, “transmission or provision” may include not only direct transmission or provision, but also indirect transmission or provision through other paths or through other devices.

In the following description, an expression recited in the singular may be construed as singular or plural unless the expression “one”, “single”, etc. is used.

In the following description, the same drawing numbers may refer to the same constituent elements and a redundant description may be avoided for brevity. The term “and/or” includes all combinations of each and at least one of the constituent elements mentioned.

In the example flowcharts described with reference to the drawings, the operation order may be changed, various operations may be merged, certain operations may be divided, and certain operations may not be performed.

In general, a server may collect data from a device at a predetermined interval. For example, when the collection period is set to 12 hours, the server may send a request to the device for necessary information, such as consumable data, count data, etc., and store a response result. However, when the user connects at a time after the data collection, the user may be provided old data. For example, when the collection cycle is 12 hours, a user who connects 11 hours after the previous data collection views the device state of 11 hours before. In an example, a device management system for synchronizing user login-based device data and its operation method are provided.

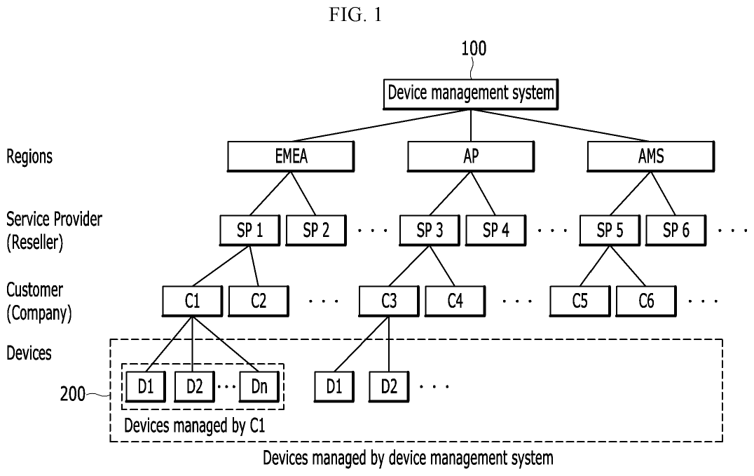

FIG. 1 illustrates an environment in which a device management system hierarchically manages devices according to an example.

Referring to FIG. 1, a device management system 100 manages information of a plurality of devices 200. In the following description, reference numeral 200 may refer to all devices managed by the device management system 100 or may refer to a sub-set of the devices managed by the device management system 100. The type of device may vary, and for example, may be a printing device, but is not limited thereto. The managed information may vary according to the type of device, the customer, and the like. For example, consumable data, count data such as the number of prints, predetermined device setting data, application data of the device, user data, etc. may be managed. In the description, information managed by the device management system 100 is called device data. The device management system 100 collects device data from each locally installed device and provides the collected device data to a device administrator. In the description, the device administrator is called an administrator.

A plurality of devices 200 are hierarchically managed. For example, a plurality of devices 200 can be layered and managed by regions, service providers (SPs), customers (C), etc. The regions, for example, may be classified into Europe, Middle East, and Africa (EMEA), Asia Pacific (AP), Americas (AMS), etc. Service providers SP1, SP2, . . . may be resellers of the respective regions. Customers C1, C2, . . . are units provided with at least one device from a service provider and may be divided into enterprise units. In an example, it may be assumed that each customer uses a plurality of devices D1, D2, . . . . For example, an administrator may be an administrator managing a device such as a printer in a customer company, may be a service reseller managing devices of customers, etc.

An administrator may access the device management system 100 using an administrator account assigned to a service provider and a customer in a user terminal. The administrator may receive information of devices included in a management scope of the administrator account and may manage the devices within an authority scope of the administrator account. For example, an administrator of the customer C1 manages devices D1, D2, . . . provided to a customer C1, and a device administrator of a service provider SP1 may manage all devices provided to subordinate customers.

The user terminal may include a computing device such as a laptop, a mobile terminal, and the like, which can access the device management system 100 through a network.

The device management system 100 is connected with the plurality of devices 200 through a network, and collects designated device data from the plurality of devices 200. In this case, there are many kinds of device data, and it takes a certain time to collect the device data. When the device management system 100 broadcasts a data request signal to all devices, there is a significant load on collecting data from all the devices at once.

Alternatively, the device management system 100 may classify all the devices into a plurality of groups, collect device data according to a collection cycle for each group, and store the collected device data in a database. For example, the device management system 100 may set a collection period to 12 hours, request device data from a specific group of devices every 12 hours, and store the collected device data in a database. However, when an administrator access is made after a long time has passed from the previous data collection, the device data provided to the administrator by the device management system 100 becomes the past device information. Therefore, periodic synchronization of all devices is inefficient, and it is not easy to provide administrators with up-to-date device data.

On the other hand, the device management system 100 may set a short collection period in order to provide the latest device data. In this case, when the device management system 100 terminates data collection before the data collection of the current cycle is completed and resumes collection from all devices, data of a device may not be continuously collected due to a short time period. Therefore, the collection cycle can only be set by appropriately extending the data collection time for all devices. Since the time required for periodic data collection is long, it is difficult to keep the information provided to the administrator up-to-date.

An example method for the device management system 100 to provide the administrator with the latest device data will be described. In particular, an example method of the device management system 100 to synchronize the device data in real time based on the login of the administrator will be described.

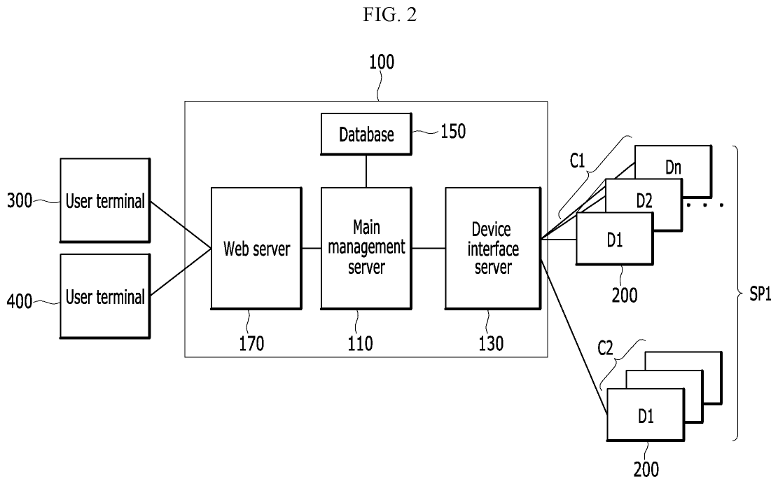

FIG. 2 is a schematic diagram of a management system according to an example.

Referring to FIG. 2, a device management system 100 includes at least one computing device operated by at least one processor. The device management system 100 may include a main management server 110, a device interface server 130, a database 150, and a web server 170. In various examples, functions of the servers may be integrated or separated. The main management server 110 implements an interface to interface with the device interface server 130, the database 150, and the web server 170. The device interface server 130 may be provided in plural. The database 150 may be provided in plural. The web server 170 may be provided in plural.

The main management server 110 may send a request for device synchronization to the device interface server 130, and store device data collected from the device interface server 130 in the database 150. The main management server 110 may periodically store the collected device data in the database 150. In an example, the main management server 110 can store collected device data in the database 150 when the administrator logs in to the web server 170.

The device interface server 130 is connected with a plurality of devices 200 in a network. The device interface server 130 may request device data from specific devices at a specific time and receive response data from the specific devices. The specific devices and the specific time points may be determined at the device interface server 130 or at the main management server 110.

The web server 170 provides administrator pages for administrators. The web server 170 may provide an administrator page including a device management page to a user terminal (300/400) connected with an administrator account. The web server 170 may interoperate with the main management server 110 to provide the latest device data to a user terminal (300/400) connected with an administrator account. As an example, the web server 170 may request synchronization with the management devices of the administrator account that is logged into the main management server 110.

Hereafter, an example method for the device management system 100 to synchronize device data through interoperation with the user terminal 300/400 connected to one or more of the plurality of devices 200 and the administrator account is described.

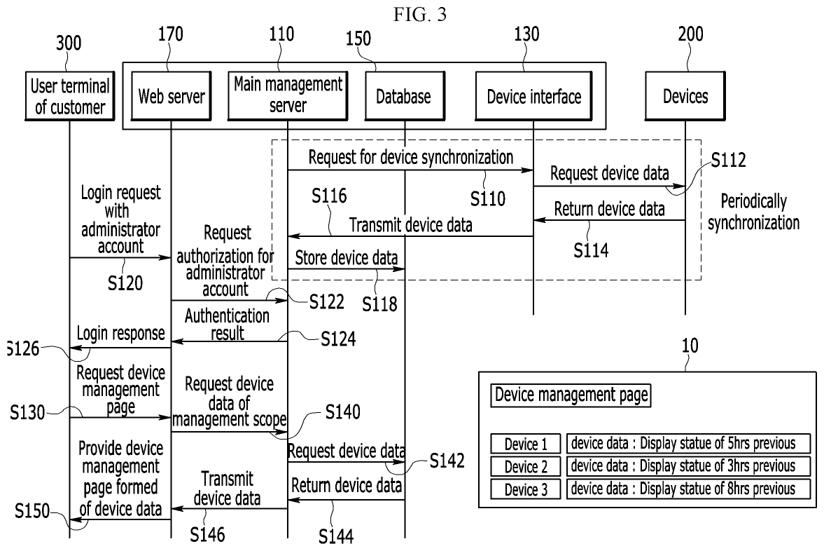

FIG. 3 is a flowchart of a method for periodic synchronization of device data according to an example.

Referring to FIG. 3, the main management server 110 sends a request for device synchronization to the device interface server 130 in operation S110. In this case, the main management server 110 may request synchronization of all devices 200 or may request synchronization of devices corresponding to a specific period.

The device interface server 130 sends a request to devices 200 for device data corresponding to a collection period in operation S112, and collects device data returned from the devices 200 in operation S114.

The device interface server 130 transmits the device data collected from the devices 200 to the main management server 110 in operation S116.

The main management server 110 stores the collected device data in the database 150 in operation S118. When the collection period is 12 hours, the devices 200 may transmit designated device data to the device interface server 130 every 12 hours. The collection timing may be set differently for each group to which the device belongs.

The user terminal 300 accesses the web server 170 and sends a request for a login for an administrator account to the web server 170 in operation S120. For example, an administrator of a customer C1 may access the web server 170 and input an administrator account (e.g., ID=C1_admin) in a login page.

The web server 170 sends a request for authorization with respect to the administrator account included in the login request to the main management server 110 in operation S122.

The main management server 110 authenticates the administrator account based on stored administrator information and transmits an authentication result to the web server 170 in operation S124. In an example, the main management server 110 can determine authority of the administrator account. The authentication result may include, for example, a management scope (e.g., C1) of the administrator account (ID=C1_admin).

The web server 170 responds to the login of the user terminal 300 based on the authentication result in operation S126. When the authentication result is success, the web server 170 may provide a login success page to the user terminal 300.

The web server 170 receives a request for a device management page from the user terminal 300 in operation S130. The device management page may display various pieces of status information of devices to be managed and provide a screen for changing predetermined information of devices within the authority of the administrator.

The web server 170 sends a request for device data that corresponds to an authority range of the administrator account to the main management server 110 in operation S140. Since the administrator account (ID=C1_admin) is authorized for the management scope (for example, C1), the web server 170 can request device data corresponding to the management scope C1. Alternatively, when the web server 170 manages devices corresponding to the management scope C1, the web server 170 can request device data of specific devices.

The main management server 110 sends a request for device data of the management scope to the database 150 in operation S142, and receives device data of the management scope from the database 150 in operation S144. The main management server 110 transmits requested device data to the web server 170 in operation S146.

The web server 170 constructs a device management page 10 using the received device data and provides the device management page 10 to the user terminal 300 in operation S150. Here, the device management page 10 may be formed of device data obtained in a collection cycle of each device. Thus, in the device management page 10, status information of a first device Device 1 may be status information collected 5 hours previous, status information of a second device Device 2 may be status information collected 3 hours previous, and status information of a third device Device 3 may be status information collected 8 hours previous. As described, when the device data is periodically synchronized, device data provided to the administrator may be different from a current status.

An example method for real-time synchronization of device data by supplementing the method for periodically synchronizing device data will be described.

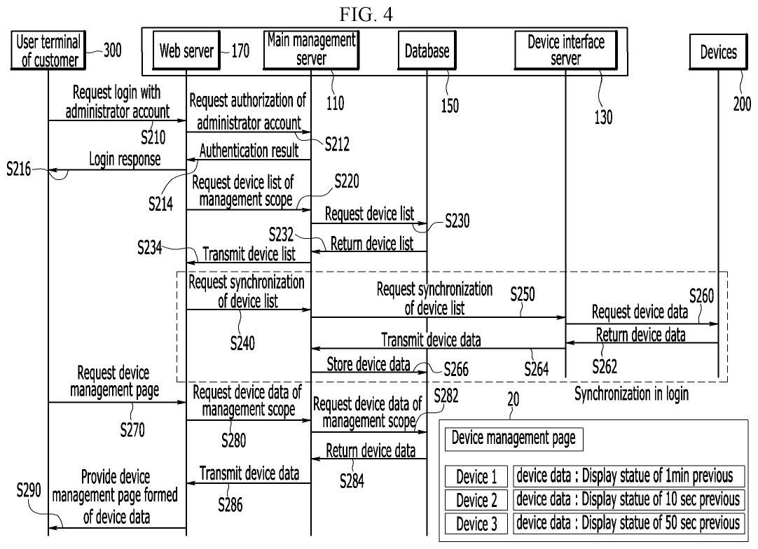

FIG. 4 is a flowchart of a method for synchronizing device data based on a login according to an example.

Referring to FIG. 4, the user terminal 300 accesses the web server 170 and sends a request for a login for an administrator account to the web server 170 in operation S210. For example, an administrator of the customer C1 may access the web server 170 and input an administrator account (e.g., ID=C1_admin) on the login page.

The web server 170 requests authorization of the administrator account included in the login request to the main management server 110 in operation S212. An authorization process may vary, and for example, when the web server 170 stores the management scope C1 of the administrator account (ID=C1_admin), it may be inquired as to whether the administrator account (ID=C1_admin) has authority of the management scope C1. Alternatively, the web server 170 may inquire the authority range of the administrator account (ID=C1_admin), and the administrator account (ID=C1_admin) may receive the management scope C1 from the main management server 110.

The main management server 110 authenticates the administrator account based on stored administrator information and transmits the authentication result to the web server 170 in operation S214.

The web server 170 responds to the login of the user terminal 300 based on the authentication result in operation S216. When the authentication result is successful, the web server 170 may provide a login success page to the user terminal 300.

When the authentication result is successful, the web server 170 sends a request for a list of devices corresponding to the management scope of the administrator account to the main management server 110 in operation S220. When the web server 170 is aware of the management scope C1 of the administrator account (ID=C1_admin), the web server 170 may request a list of devices corresponding to the management scope by transmitting the management scope C1 to the main management server 110. Alternatively, when the main management server 110 is aware of the management scope C1 of the administrator account (ID=C1_admin), the web server 170 may request a list of devices corresponding to the management scope of the administrator account by transmitting the administrator account (ID=C1_admin) to the main management server 110.

The main management server 110 sends a request for a device list of the management scope C1 to the database 150 in operation S230.

The main management server 110 receives the requested device list of the management scope C1 from the database 150 in operation S232. The main management server 110 may, for example, acquire a list of devices D1, D2, . . . , Dn included in the management scope C1.

The main management server 110 transmits the acquired device list to the web server 170 in operation S234. The web server 170 may store the device list included in the management scope C1. However, locally stored information may not be the latest information, and thus the web server 170 may determine a device list stored in a central database 150.

The web server 170 transmits a synchronization request with respect to the device list to the main management server 110 in operation S240. The synchronization request with respect to the device list includes a device list and may further include a data item collected from each device. The data item to be collected may vary depending on devices, and may be pre-designated by an administrator, or may be pre-designated depending on a device type.

The main management server 110 sends a request for synchronization with respect to the device list to the device interface server 130 in operation S250.

The device interface server 130 sends a request for device data to devices 200 included in the device list in operation S260, and collects device data received from the devices 200 in operation S262.

The device interface server 130 transmits the device data collected from the devices 200 to the main management server 110 in operation S264.

The main management server 110 stores the collected device data in the database 150 in operation S266. Since the number of devices included in the device list is a portion of all devices, it takes a short time to collect the device data. Therefore, since the data of the devices included in the management scope C1 are stored in the database 150 in a very short time (for example, within 2 minutes), the devices included in the database 150 and the management scope C1 are synchronized in real time.

The user terminal 300 sends a request for a device management page to the web server 170 in operation S270. When the user terminal 300 enters a device management page, the entered page is requested to the web server 170.

The web server 170 sends a request for device data corresponding to a management scope of the administrator account to the main management server 110 in operation S280.

The main management server 110 sends a request for device data of a list of devices D1, D2, . . . , Dn included in the management scope C1 to the database 150 in operation S282, and receives the requested device data from the database 150 in operation S284.

The main management server 110 transmits the requested device data to the web server 170 in operation S286.

The web server 170 forms a device management page 20 using the received device data and provides the device management page 20 to the user terminal 300 in operation S290.

In this case, the device management page 20 is a screen formed of device data acquired at a time when the administrator logs in with the administrator account. Thus, in the device management page 20, status information of a first device Device 1 may be status information collected 1 minute previous, status information of a second device Device 2 may be status information collected 10 seconds previous, and status information of a third device Device 3 may be status information collected 50 seconds previous. On the other hand, the login time does not mean only after the login but may be within a predetermined time before and after the login.

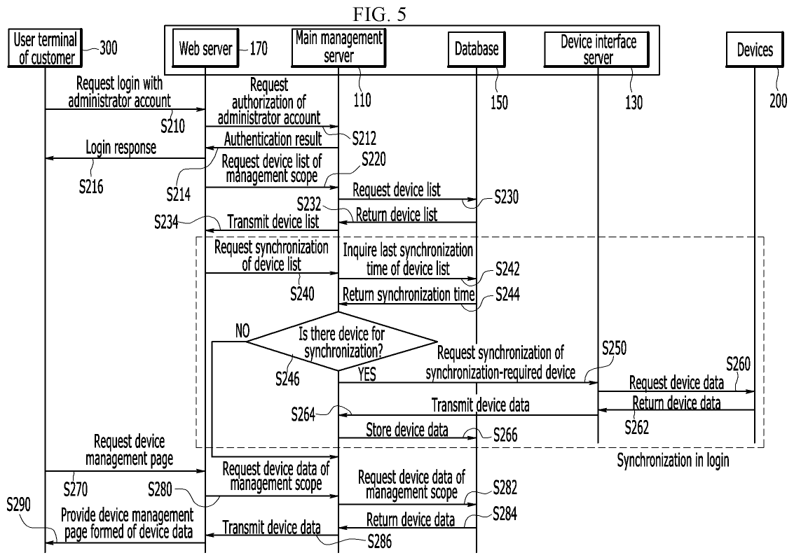

FIG. 5 is a flowchart of a method for synchronizing device data based on a login according to an example.

Referring to FIG. 5, when synchronization with devices included in a management scope of an administrator account is carried out at the time when the administrator logs in with the administrator account as illustrated in the example of FIG. 4, unnecessary synchronization may be repeated. In order to prevent such a synchronization repetition, the main management server 110 may determine whether synchronization is necessary before requesting device synchronization with respect to a device list. In the example of FIG. 5, operations S210 through S240 and S250 through S290 are substantially the same as those in FIG. 4 so that a redundant description may not be provided.

Similar to the example of FIG. 4, the web server 170 of FIG. 5 transmits a synchronization request with respect to a device list to the main management server 110 in operation S240.

In the example of FIG. 5, the main management server 110 sends an inquiry regarding the last synchronization time of each device in the device list to the database 150 in operation S242 before sending a request for device synchronization with respect to the device list to the device interface server 130 in operation S250.

The main management server 110 receives the device-specific last synchronization time from the database 150 in operation S244. The main management server 110 determines whether synchronization is needed based on the device-specific last synchronization time in operation S246. When the last synchronization time of the devices is within a reference time (for example, 10 minutes) from the current time, the main management server 110 may omit the synchronization procedure for the device list. That is, when the devices are already synchronized within the reference time (for example, 5 minutes previous), the main management server 110 may omit the synchronization procedure and maintain the already stored device data. The main management server 110 may determine whether synchronization is required for each device included in the device list and determine a synchronization-required device.

When a duration since the last synchronization time of at least some of the devices in the device list is greater than the reference time (for example, 10 minutes), the main management server 110 sends a request for the device interface server 130 to synchronize the devices that require synchronization in the device list in operation S250. The main management server 110 may request synchronization for only some devices when the last synchronization time of some devices in the device list is earlier than the reference time. Alternatively, the main management server 110 may request synchronization for the entire device list if there is any device for synchronization in the device list. That is, if a device was synchronized before the reference time (for example, 30 minutes previous), the main management server 110 may proceed with the synchronization procedure.

As described, the main management server 110 quickly collects device data to be provided to the administrator at the time the administrator logs in, while preventing a network traffic increase and server performance deterioration by frequent synchronization based on a synchronization buffer time.

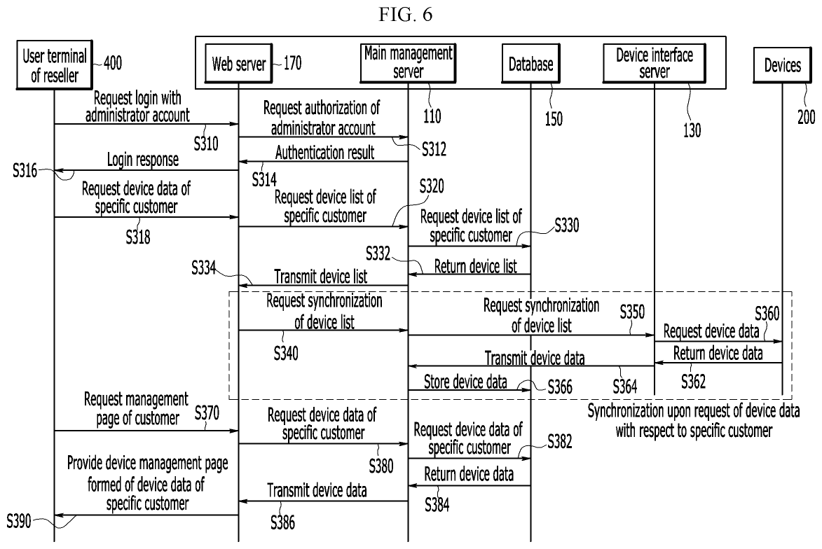

FIG. 6 is a flowchart of a method for synchronizing device data based on a login according to an example.

Referring to FIG. 6, a case in which a service provider SP1 that manages a plurality of customers (C1, C2, . . . ) accesses the web server 170 with an administrator account (ID=SP1_admin) may be the same as a case in which a customer C1 accesses the web server 170 with an administrator account (ID=C1_admin). The number of devices managed by the service provider SP1 may be more than the standard, and thus it may not be easy to synchronize devices of a plurality of customers (C1, C2, . . . ) at once. Thus, when the service provider SP1 accesses the web server 170 with the administrator account (ID=SP1_admin), the service provider SP1 may designate a specific customer among the plurality of customers.

A user terminal 400 accesses the web server 170 and sends a request for a login with respect to an administrator account to the web server 170 in operation S310. For example, an administrator of the service provider SP1 can access the web server 170 and input an administrator account (for example, ID=SP1_admin) on a login page.

The web server 170 sends a request for authorization of the administrator account included in the login request in operation S312. The main management server 110 authenticates the administrator account based on stored administrator information and transmits the authentication result to the web server 170 in operation S314. The main management server 110 may authenticate that the administrator account (ID=SP1_admin) has management authority with respect to the plurality of customers (C1, C2, . . . ).

The web server 170 responds to the login of the user terminal 400 based on the authentication result in operation S316. When the authentication result is successful, the web server 170 may provide a login success page to the user terminal 400.

The web server 170 may receive a device data request from the user terminal 400 for a particular customer (e.g., C1) among the plurality of customers having management authority in operation S318. A device data request time with respect to the particular customer (e.g., C1) may be variously defined, and for example, it may be a time at which the user terminal 400 enters a page of the particular customer or a time at which the user terminal 400 selects a synchronization button for the particular customer.

The web server 170 sends a request for a device list of the particular customer C1 to the main management server 110 in operation S320.

The main management server 110 sends a request for the device list of the particular customer C1 to a database 150 in operation S330.

The main management server 110 receives the requested device list of the particular customer C1 from the database 150 in operation S332. The main management server 110 may acquire, for example, a list of devices (D1, D2, . . . Dn) of the particular customer C1.

The main management server 110 transmits the acquired device list to the web server 170 in operation S334. The web server 170 may store the device list of the particular customer C1. However, because locally stored information may not be the latest information, the web server 170 may check a device list stored in the central database 150.

The web server 170 transmits a synchronization request with respect to the device list to the main management server 110 in operation S340. The synchronization request with respect to the device list includes the device list and may include a data item to be collected from each device. The data item to be collected may vary depending on devices and may be pre-designated by an administrator or may be pre-designated according to a type of the device.

The main management server 110 sends a request for device synchronization with respect to the device list to the device interface server 130 in operation S350. As described above with reference to FIG. 5, before requesting device synchronization for the device list to the device interface server 130, the main management server 110 may send a request for the last synchronization time of the device list to the database 150, and determine whether to request synchronization based on the last synchronization time of the device list.

The device interface server 130 sends a request for the device data to the devices 200 included in the device list in operation S360 and collects the device data returned from the devices 200 in operation S362.

The device interface server 130 transmits the device data collected from devices 200 to the main management server 110 in operation S364.

The main management server 110 stores the collected device data in the database 150 in operation S366. Since the number of devices included in the device list is a portion of all devices, it takes a shorter time to collect the device data. Thus, data of the devices of the particular customer C1 in the database 150 are stored in a very short time (for example, within 2 minutes), so that the devices of the database 150 and the particular customer C1 are synchronized in real time.

The user terminal 400 sends a request for a device management page of the particular customer C1 to the web server 170 in operation S370. When the administrator enters the device management page of the particular customer C1 on the screen, the user terminal 400 may request device data constituting the device management page of the particular customer C1 from the web server 170.

The web server 170 sends a request for the device data of the particular customer C1 to the main management server 110 in operation S380.

The main management server 110 requests the device data of the particular customer C1 from the database 150 in operation S382. The main management server 110 transmits the requested device data to the web server 170 in operation S384. The main management server 110 transmits the requested device data to the web server 170 in operation S386.

The web server 170 constructs a device management page using the received device data of the particular customer C1 and provides the device management page to the user terminal 400 in operation S390.

In this case, since the device management page is composed of device data obtained when the administrator logs in with an administrator account, the device management page may provide the administrator with the latest status information of the devices as shown in the device management page 20.

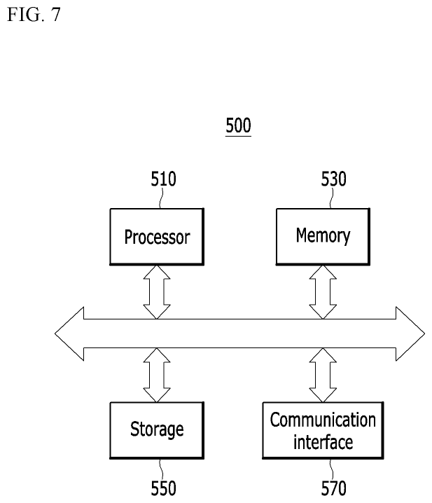

FIG. 7 is a schematic diagram of hardware of a computing device according to an example.

A device management system 100, a device 200, a user terminal 300, and a user terminal 400 may respectively be computing devices operating by at least one processor, and may execute a program where instructions for execution of operations of the present invention are included.

Referring to FIG. 7, hardware of a computing device 500 may include at least one processor 510, a memory 530, a storage unit 550, and a communication interface 570, which may be connected through a bus. In addition, hardware such as an input device, an output device, a power supply, etc. may be included.

The computing device 500 can be loaded with a variety of software, including an operating system that can run programs. As a device for controlling the operation of the computing device 500, the processor 510 may be a processor of various types for processing instructions included in a program, and may be for example, a central processing unit (CPU), a microprocessor unit (MPU), a microcontroller unit (MCU), a graphic processing unit (GPU), and the like. The memory 530 may load a corresponding program such that instructions described to execute an example operation as described above are processed by the processor 510. The memory 530 may be, for example, a read only memory (ROM), a random access memory (RAM), and the like. The storage unit 550 may store various data, programs, etc. required to execute an operation of the present invention. The communication interface 570 may be a wired/wireless communication module.

As described, according to various examples, the device management system 100 can collect the latest device data through synchronization with devices included in a management scope of an administrator at a login time of the administrator.

According to various examples, the device management system 100 can address a problem of non-real time collection of device data, while reducing time and load required for synchronization of data of all devices.

According to various examples, since the administrator receives device data, which is collected close to real time, from the device management system 100, the administrator may not experience confusion due to a difference between information checked on a device management page and the current information of the device.

Various examples as described above are not only implemented by an apparatus and a method, but may be implemented by a program or a non-transitory recording medium having the program recorded therein that realizes functions corresponding to the configurations of the exemplary embodiments of the present invention.

While various examples have been described, it is to be understood that the invention is not limited to the disclosed examples. On the contrary, it is intended to cover various modifications and equivalent arrangements included within the spirit and scope of the appended claims.

What is claimed is:

1. A computing device comprising:
at least one memory; and
at least one processer that executes instructions of a program loaded in the memory,
wherein the program comprises instructions to:
receive a login request with respect to an administrator account from a user terminal;
authenticate the administrator account and determine a device list included in a management scope of the administrator account;
collect device data from devices included in the device list and store the collected device data in a database; and
provide the stored device data to the user terminal.

2. The computing device of claim 1, wherein the instructions to determine the device list comprise instructions to authenticate authorization with respect to the administrator account and determine the management scope with the authorization.

3. The computing device of claim 1, wherein the instructions to provide the stored data to the user terminal comprise instructions to:
receive a request for a device management page from the user terminal; and
provide a device management page formed by using the collected device data to the user terminal.

4. The computing device of claim 1, wherein the instructions to store the collected device data in the database comprise instructions to:
check a last synchronization time of devices included in the device list in the database; and
collect device data from devices included in the device list when the last synchronization time is earlier than a reference time.

5. The computing device of claim 4, wherein, when the last synchronization time is within a reference time, the instructions to collect the device data from devices included in the device list comprise instructions to maintain the device data stored in the database.

6. The computing device of claim 1, wherein the program further comprises instructions to:
execute periodic collection of device data of a plurality of devices; and
store the collected device data in the database,
wherein the plurality of devices are included in the device list.

7. An operating method of a main management server, the operating method comprising:
authenticating an administrator account requested from a web server;
transmitting a device list included in a management scope of the administrator account to the web server;
receiving a synchronization request with respect to the device list from the web server;
storing device data collected from devices included in the device list in a database;
receiving a request for device data of the management scope from the web server; and
transmitting device data of the management scope that is stored in the database to the web server,
wherein the device data is displayed on a screen provided to a user terminal, which has input the administrator account, by the web server

8. The operating method of claim 7, wherein the storing of the collected device data in the database comprises:
transmitting a synchronization request with respect to devices included in the device list to a device interface server, which interoperates with a plurality of devices;
receiving collected device data from the device interface server; and
storing the collected device data in the database.

9. The operating method of claim 7, wherein the transmitting of the device list is carried out when a device list included in a management scope of the administrator account is requested from the web server.

10. The operating method of claim 7, wherein the storing of the device data in the database, comprises:
checking the last synchronization time of devices included in the device list from the database; and
collecting device data from devices included in the device list when the last synchronization time is earlier than a reference time.

11. The operating method of claim 7, wherein the database stores device data that are periodically collected from a plurality of devices including devices included in the device list.

12. The operating method of claim 7, wherein the transmitting of the device list comprises transmitting a device list included in a management scope of the administrator account, or a device list included in a lower management scope requested from the web server among the management scope of the administrator account.

13. An operation method of a web server, the operation method comprising:
receiving a login request with respect to an administrator account from a user terminal;
sending a request for a device list included in a management scope of the administrator account to a main management server;
receiving the device list from the main management server;
transmitting a synchronization request with respect to the device list to the main management server;
sending a request for device data of the management scope to the main management server when receiving a device management page from the user terminal; and
providing a device management page formed by using device data received from the main management server to the user terminal.

14. The operation method of the web server of claim 13, further comprising:
after receiving the login request, requesting authorization with respect to the administrator account to the main management server; and
receiving an authorization request from the main management server.

15. The operation method of the web server of claim 13, wherein the device data received from the main management server includes data collected after transmitting a synchronization request with respect to the device list to the main management server, or data collected before a predetermined time from a transmission time of the synchronization request.
